(19) United States
(12) Patent Application Publication
(10) Pub. No.: US 2016/0292594 A1
(43) Pub. Date: Oct. 6, 2016

(54) FACILITATING TRANSPORTATION PROVIDERS TO MAKE RECOMMENDATIONS FOR PASSENGERS AT DIFFERENT STAGES RELATED TO JOURNEYS

(71) Applicant: NIIT Technologies Ltd, New Delhi (IN)

(72) Inventors: Kanaklata Narayanan, Bangalore (IN); Vikram Nagaraja RAO, Bangalore (IN); Deepesh Palamoli Chaliyadath, Bangalore (IN); Raghunandan Seegappa Shetty, Bangalore (IN)

(21) Appl. No.: 15/084,581

(22) Filed: Mar. 30, 2016

(30) Foreign Application Priority Data
Mar. 30, 2015 (IN) 1652/CHE/2015

(51) Int. Cl. G06Q 10/02; G06Q 50/14; G06N 5/04

(52) U.S. Cl. CPC G06Q 10/02; G06N 5/04; G06Q 50/14

(57) ABSTRACT

An aspect of the present disclosure facilitates transportation providers to make recommendations for passengers at different stages related to journeys. In one embodiment, a recommendation system determines a current stage of a passenger on a current journey, the current journey containing a sequence of stages including the current stage. The recommendation system then identifies a set of recommendations for the current stage based on activities of the passenger in a first set of stages preceding the current stage according to the sequence and then provides the set of recommendations to the passenger.

### PRIORITY CLAIM

The instant patent application is related to and claims priority from the co-pending provisional India patent application entitled, “A SELF-LEARNING REAL TIME CONTEXT MULTI STAGE RECOMMENDER”, Serial No.: 1652/CHE/2015, Filed: 30 Mar. 2015, which is incorporated in its entirety herewith to the extent not inconsistent with the disclosure herein.

### BACKGROUND OF THE DISCLOSURE

1. Technical Field

The present disclosure relates to transport management systems and more specifically to facilitating transportation providers to make recommendations for passengers at different stages related to journeys.

2. Related Art

Transportation providers' transport or move people (travelers) between various locations. Airlines, railways and bus lines are common examples of such transportation providers, though the description below is provided substantially with respect to airlines.

There are various stages related to journeys of passengers. For example, a passenger may be viewed as browsing flights/ticket information for purchasing a ticket in a booking stage. The duration between the time of purchase of a ticket and the date of flight may be viewed as the pre-flight stage. The process of performing “check-in” for the flight (formally registering the passenger for the flight either online and/or physically at the airport) may be viewed as a check-in stage.

When the passenger is physically present at the airport (until boarding the flight), the corresponding duration may be viewed as at-the-airport stage Similarly, there are inside-the-aircraft-stage and at-the-destination stage (post-arrival at the destination) in the corresponding durations.

There is a general need for transportation providers to make recommendations (offers or suggestions for various products, services, entertainment, etc) to the passengers, as suitable in different stages related to journeys. Aspects of the present disclosure address such a requirement, as described below with examples.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present invention can be implemented.

FIG. 2 is a flow chart illustrating the manner in which transportation providers are facilitated to make recommendations for passengers at different stages related to journeys according to an aspect of the present disclosure.

FIG. 3 is an example implementation of a recommendation system.

FIGS. 4A-4F depicts sample recommendations provided to a passenger at different stages related to a current journey.

FIG. 5 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates transportation providers to make recommendations for passengers at different stages related to journeys. In one embodiment, a recommendation system determines a current stage of a passenger on a current journey, the current journey containing a sequence of stages including the current stage. The recommendation system then identifies a set of recommendations for the current stage based on activities of the passenger in a first set of stages preceding the current stage according to the sequence and then provides the set of recommendations to the passenger.

According to another aspect, a passenger data indicating a corresponding set of activities performed by the passenger in each of the first set of stages is maintained. The recommendation system identifies the set of recommendations for the current stage by examining the passenger data. The recommendation system also adds to the passenger data, a current set of activities performed by the passenger in the current stage.

In one embodiment, the passenger data also contains a historical data and a profile data, with the historical data indicating activities performed by the passenger during prior journeys preceding the current journey, and the profile data indicating values for various profile parameters of the passenger. The recommendation system identifies the set of recommendations for the current stage by examining the historical data and the profile data, in addition to the corresponding set of activities (specified as part of the passenger data).

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

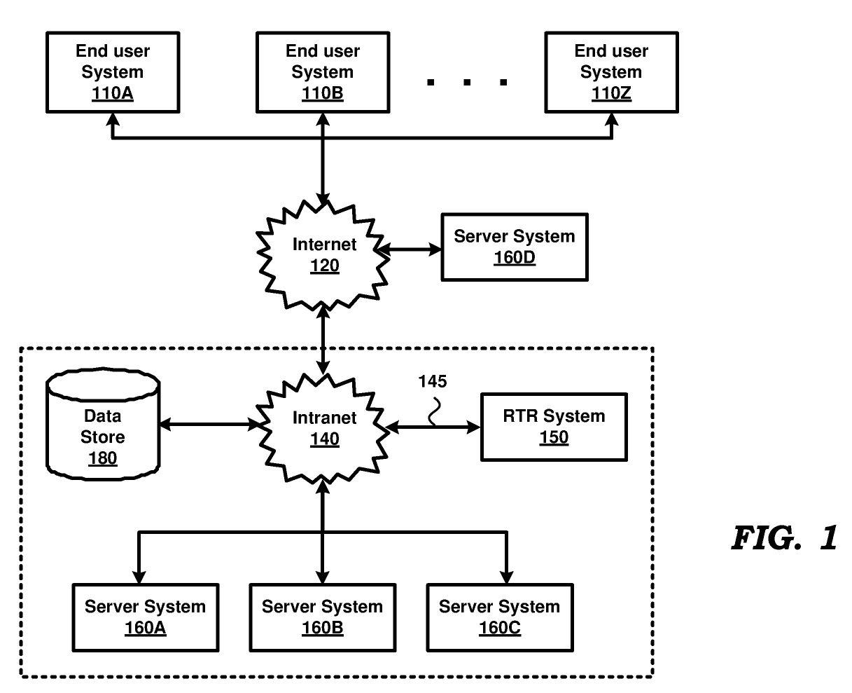

FIG. 1 is a block diagram illustrating an example environment (computing system) in which several aspects of the present invention can be implemented. In one embodiment, the computing system of FIG. 1 is provided by an airline (transportation provider) for engaging with passengers. The block diagram is shown containing end user systems 110A-110Z, Internet 120, intranet 140, server systems 160A-160D, real time recommendation (RTR) system 150 and data store 180.

Merely for illustration, only representative number/type of systems is shown in FIG. 1. Many environments often contain many more systems, both in number and type, depending on the purpose for which the environment is designed. Each block of FIG. 1 is described below in further detail.

Intranet 140 represents a network providing connectivity between server systems 160A-160C, data store 180, and RTR system 150, all provided within an enterprise or domain (shown with dotted boundaries) of the airline. Internet 120 extends the connectivity of these (and other systems of the enterprise) with external systems such as end user systems 110A-110Z. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by intranet 140 and Internet 120.

Data store 180 represents a non-volatile (persistent) storage facilitating storage and retrieval of a collection of data by applications executing in server systems 160A-160C (and also RTR system 150). Data store 180 may be implemented as a database server using relational database technologies and accordingly provide storage and retrieval of data using structured queries such as SQL (Structured Query Language). Alternatively, data store 180 may be implemented as a file server providing storage and retrieval of data in the form of files organized as one or more directories, as is well known in the relevant arts.

Each of end user systems 110A-110Z represents a system such as a personal computer, workstation, mobile device, tablets, etc., used by users (potential passengers of the airline) to generate (client) requests directed to applications executing in server systems 160A-160D. In the case of an airline enterprise, an end user system may also represent an in-flight entertainment (IFE) console, kiosk, etc. or any end user device which provides a user interface for electronic/digital engagement.

The client requests may be generated using appropriate user interfaces (e.g., web pages provided by an application executing in a server system, a native user interface provided by a portion of the application downloaded from the server system, etc.). In general, an end user system requests a (server) application for performing desired tasks and receives corresponding responses containing the results of performance of the requested tasks. Each client request is sent in the form of an IP packet directed to the desired server system (and application), with the IP packet including data identifying the desired tasks in the payload portion.

Each of server systems 160A-160D represents a server, such as a web/application server, executing (server) applications capable of performing tasks requested by users/passengers using one of end user systems 110A-110Z. A server system may use data stored internally (for example, in a non-volatile storage/hard disk within the server system), external data (e.g., maintained in data store 180) and/or data received from external sources (e.g., from the user) in performing the requested tasks. The server system then sends the result of performance of the tasks to the requesting end user system (one of 110A-110Z). The results may be accompanied by specific user interfaces (e.g., web pages) for displaying the results to the requesting user.

It may be observed that some of the server systems (such as 160A-160C) are shown internal to the enterprise (within the dotted boundary), while other server systems (such as 160D) are shown external to the enterprise. The airline uploads desired content to such external server systems (160D), which in turn streams the uploaded content, to the passengers of the airline using end user systems 110A-110Z. Examples of external server systems are social network servers, video/image sharing servers, etc.

It may be appreciated that for a journey, a user/passenger (using one of end user systems 110A-110Z) may engage with different server systems (in particular, the server applications executing there) at different stages of the journey. Based on such engagements, the airline may wish to make recommendations (offers or suggestions for various products, services, entertainment, etc) to the passenger, as suitable in different stages related to the journey.

Real time recommendation (RTR) system 150, provided according to several aspects of the present disclosure, facilitates the airline (in general, a transportation provider) to make such recommendations, as described below with examples.

### 3. Making Recommendations to Passengers at Different Stages

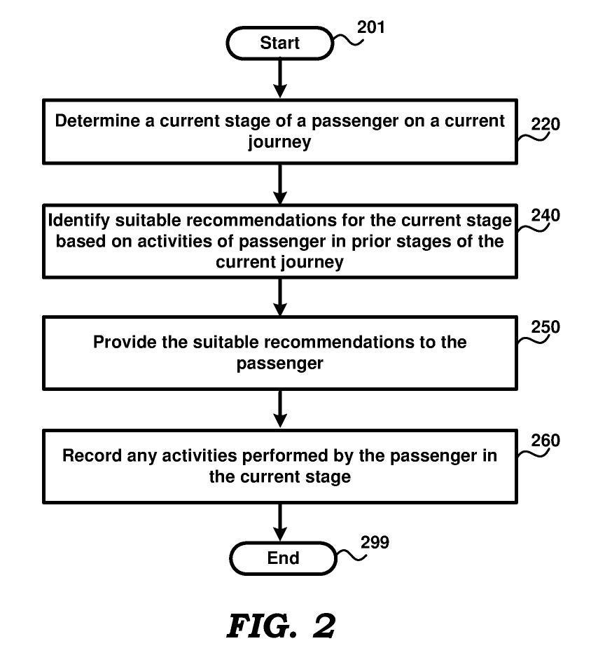

FIG. 2 is a flow chart illustrating the manner in which transportation providers are facilitated to make recommendations for passengers at different stages related to journeys according to an aspect of the present disclosure. The flowchart is described with respect to RTR system 150 of FIG. 1 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 220.

In step 220, RTR system 150 determines a current stage of a passenger on a current journey, potentially in cooperation with other server systems. The current stage of the passenger may be determined based on the activities performed by the passenger. For example, in response to receiving an indication from a server application that the passenger has purchased a ticket for a flight, RTR system 150 determines that the current stage of the passenger is the pre-flight stage only if the current date is before the date of the flight. In one embodiment, when the current date equals the date of the flight, RTR system 150 determines that the current stage of the passenger is check-in stage.

In step 240, RTR system 150 identifies suitable recommendations for the current stage based on activities of the passenger in prior stages of the current journey. As described below in examples, the activities cover both passenger provided inputs to digital systems of the airline and also electronic transactions of the passengers (e.g., purchase at a hotel at the airport) with digital systems of vendors, who are not part of the airline.

In step 260, RTR system 150 provides the suitable recommendations to the passenger. The recommendations may be provided directly from RTR system 150 to the end user system of the passenger or through server applications executing in server systems 160A-160C. The provided suitable recommendations may then be displayed to the passenger (for example, on a display of a mobile phone of the passenger).

In step 280, RTR system 150 records any activities performed by the passenger in the current stage (as part of a passenger data). The activities thus recorded for the current stage forms the basis for identifying (step 240) the recommendations in stages succeeding the current stage. Any data pertinent to identifying recommendations may be recorded as part of the passenger data. The flow chart ends in step 299.

It may be appreciated that the steps noted above may be performed at various time instances, thereby enabling RTR system 150 to determine that the passenger is at different stages of the journey and provide recommendations accordingly. By providing recommendations for a current stage based on the activities performed in prior stages, the airline is facilitated to better engage with their passengers and to improve the user experience during the journey.

The manner in which RTR system 150 makes recommendations for passengers at different stages related to journeys according to FIG. 2 is illustrated below with examples.

### 4. Illustrative Example

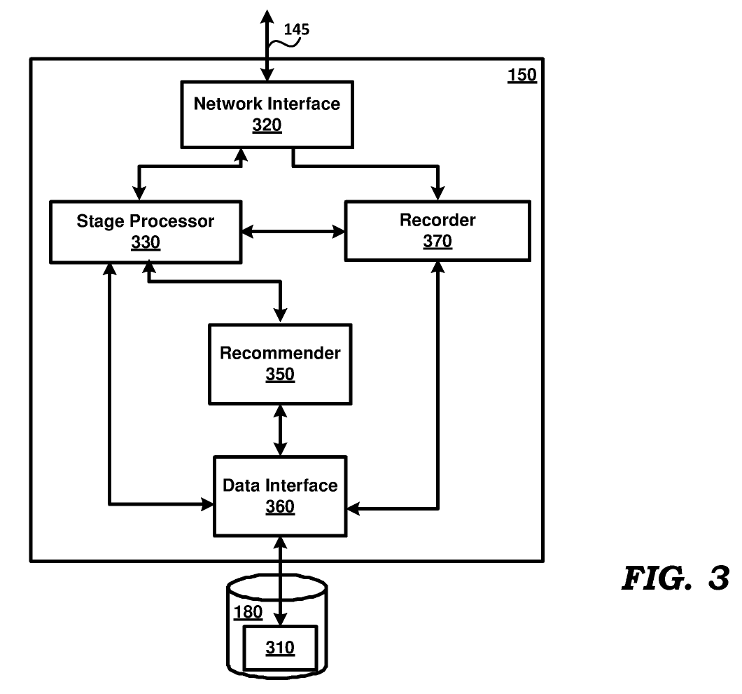

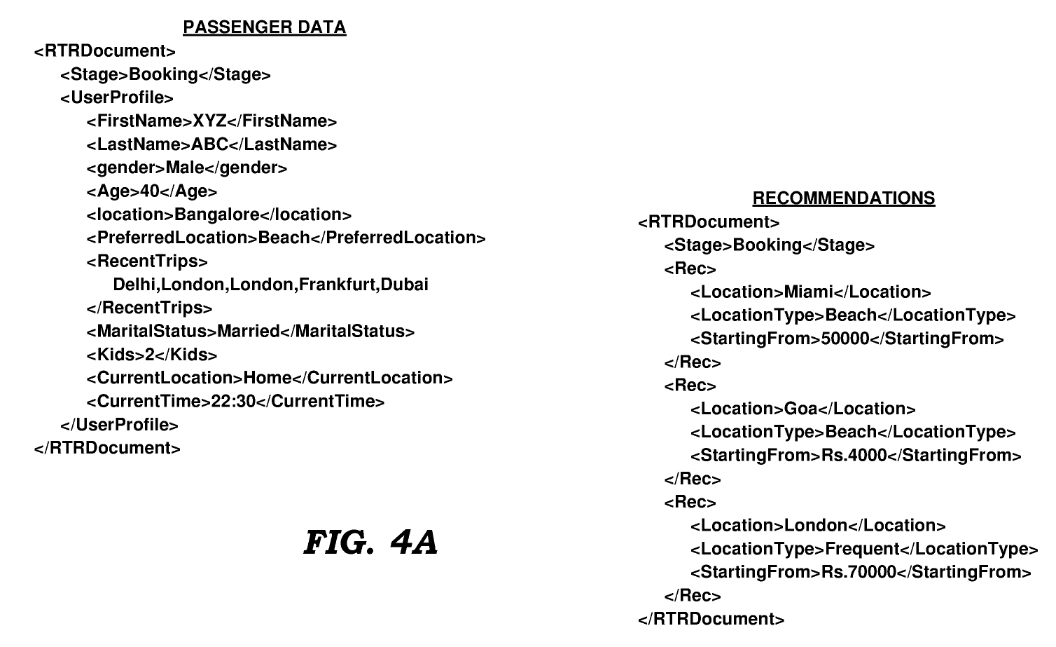

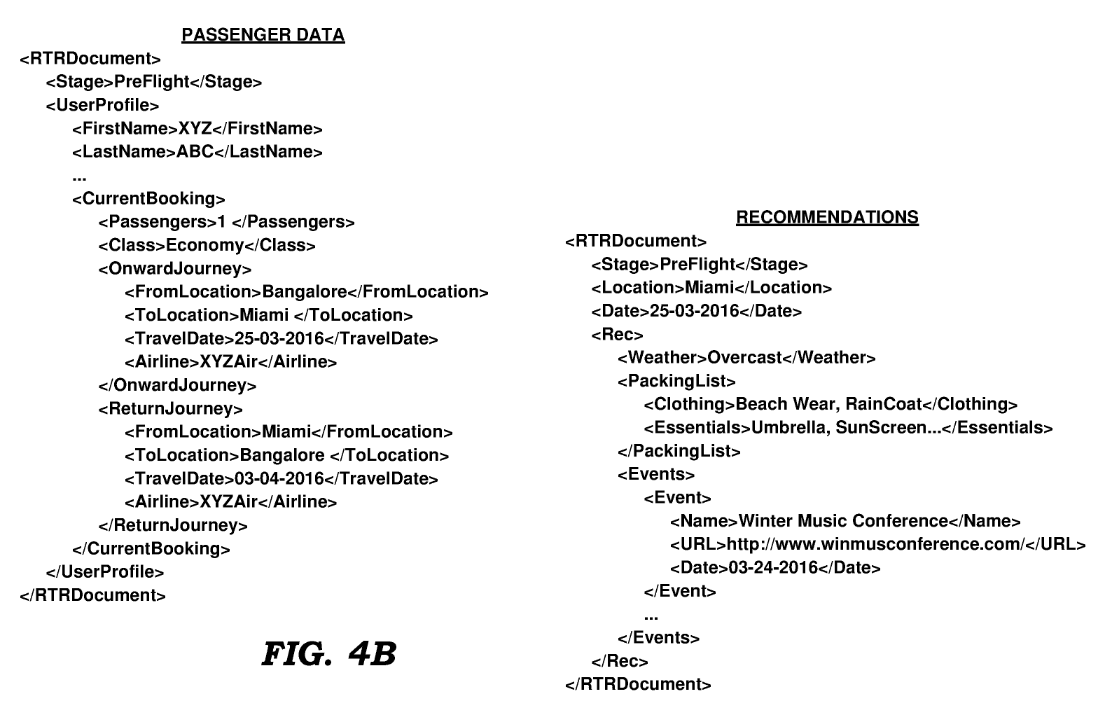

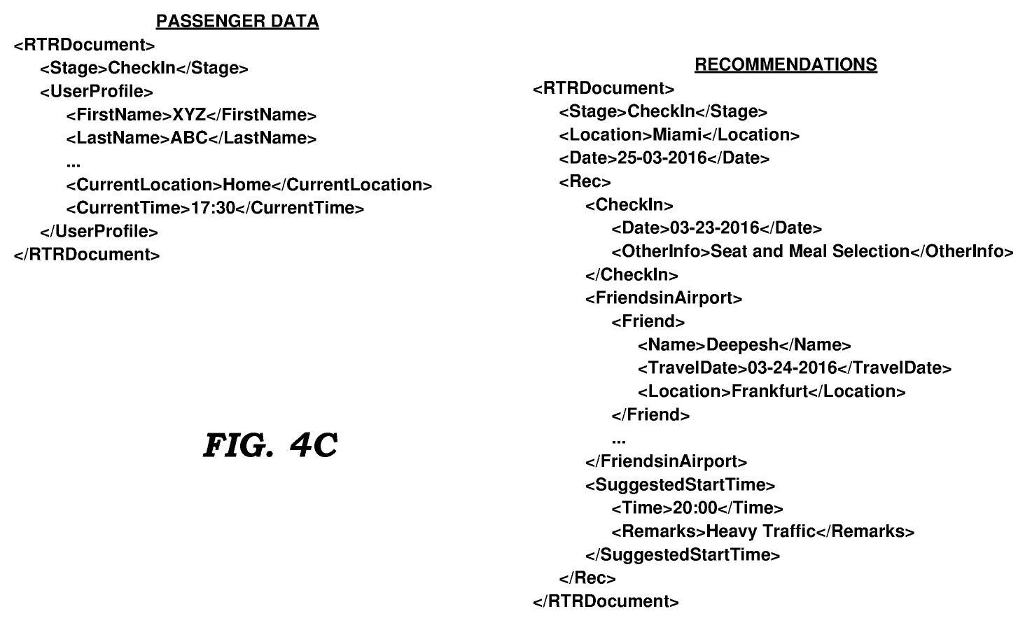

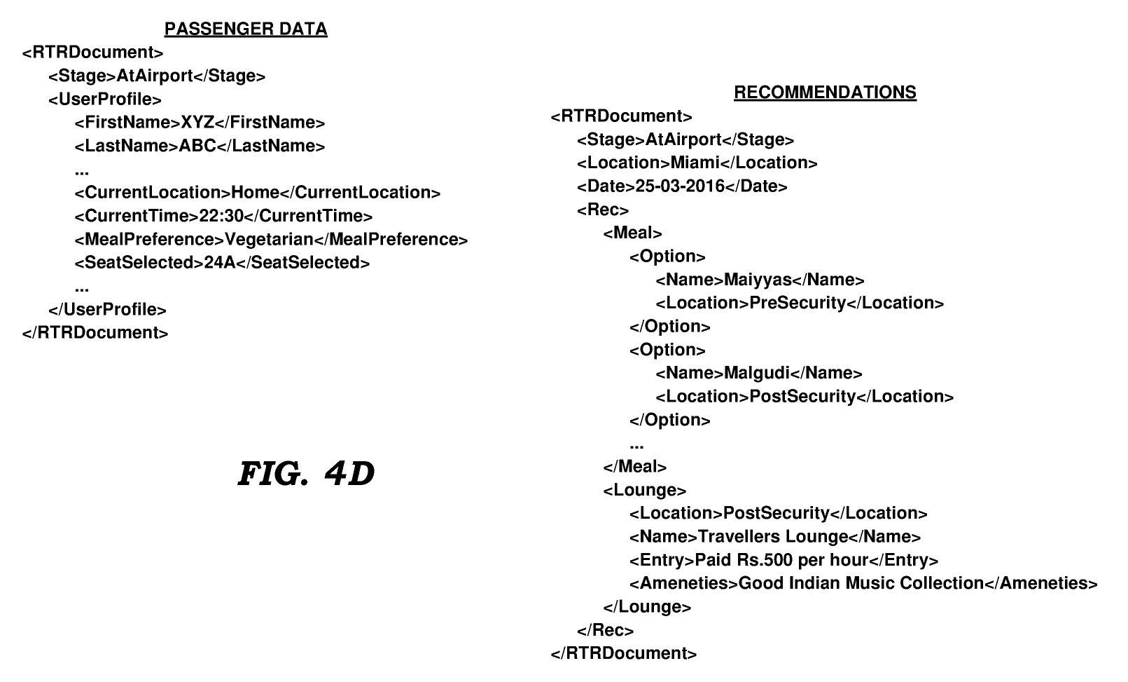

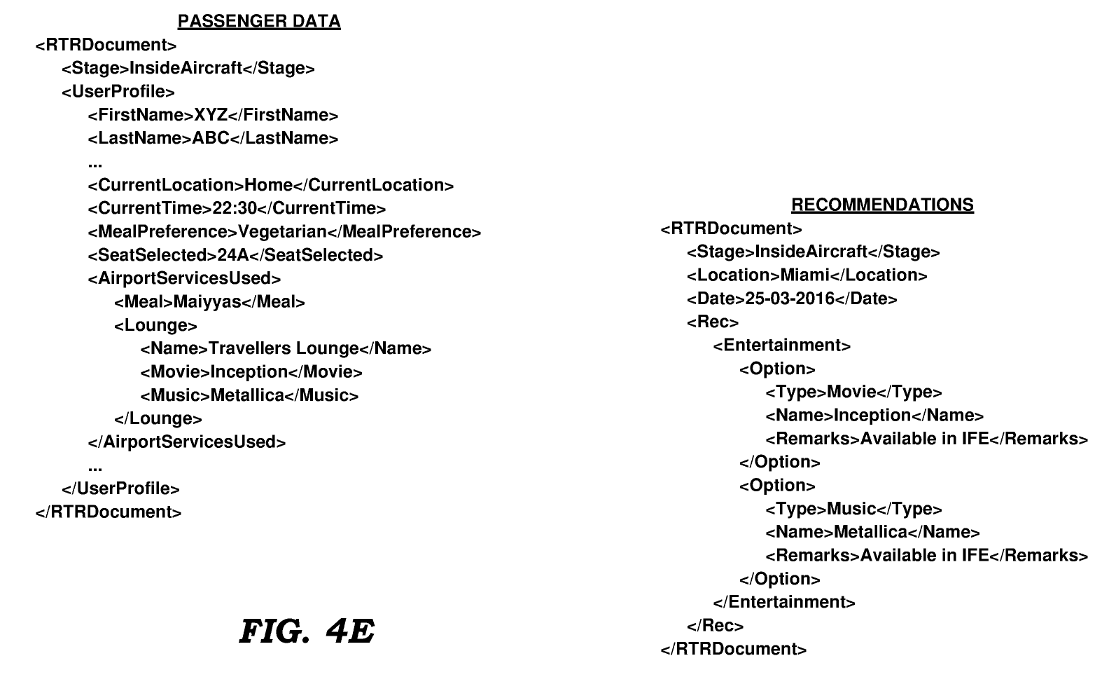

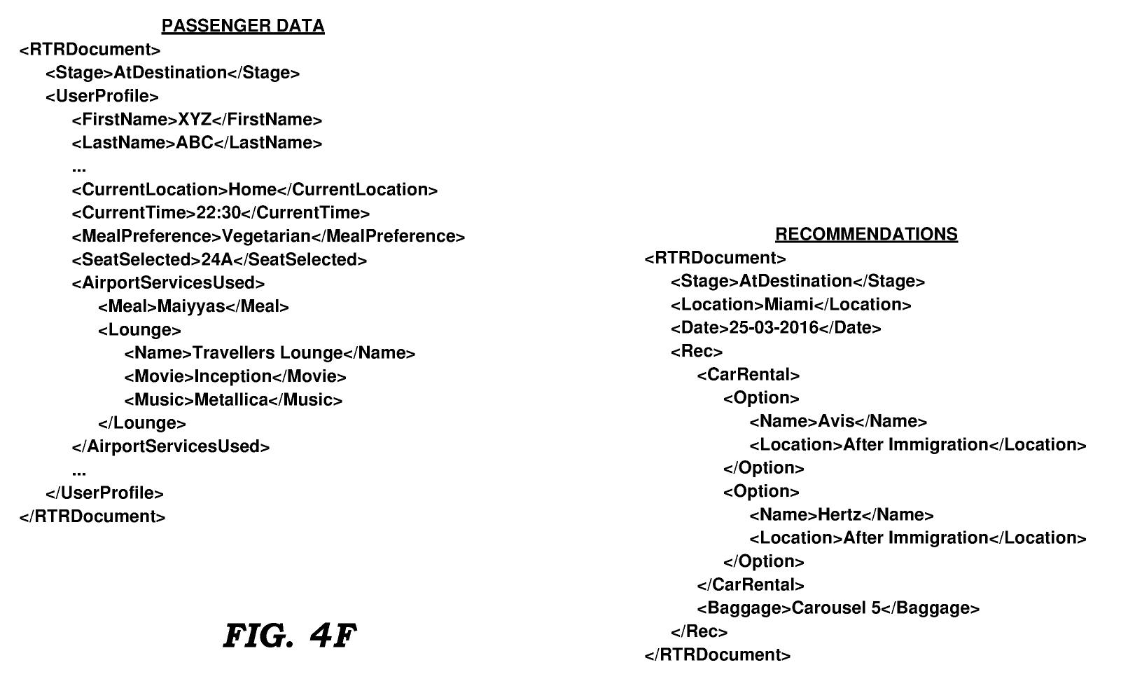

FIGS. 3 and 4A-4F together illustrate the manner in which an airline is facilitated to make recommendations for passengers at different stages related to journeys in one embodiment. Each of the Figures is described in detail below.

FIG. 3 is an example implementation of a real time recommendation system (150). RTR system 150 is shown containing network interface 320, stage processor 330, recommender 350, data interface 360 and recorder 370, while data store 180 is shown containing passenger data 310. Each of the blocks is described in detail below.

For illustration, the operation of the recommendation system for a single passenger is described in detail below. However, the features of the present invention may be implemented for a large number and/or type of passengers as well, as will be apparent to one skilled in the relevant arts by reading the disclosure herein.

Passenger data 310 specifies the corresponding set of activities performed by a passenger in each of a sequence of stages of a current journey. Passenger data 310 may be stored in corresponding tables (or as files) in data store 180. Though passenger data 310 is shown for a single passenger, similar passenger data may be maintained for other (potential) passengers/users in data store 180, as will be apparent to one skilled in the relevant arts.

In one embodiment, the passenger data also contains historical data and profile data of the passenger. The historical data indicates activities performed by the passenger during prior journeys preceding the current journey. The historical data may be generated by maintaining the passenger data of prior journeys of the passenger in data store 180. The profile data indicates values for various profile parameters (such as age, gender, married/unmarried, etc.) of the passenger. The values of the profile parameters may be provided/input by the passenger at different stages or may be retrieved by accessing a social media page of the passenger (for example, a Facebook™ page of the of the passenger).

Network interface 320 receives (via path 145) packets from external systems and forwards the packets to other blocks in RTR system 150. In particular, network interface 320 receives details of the activities performed by the passenger related to the current journey and also values of the profile parameters (from the social media sites) and forwards the received details to recorder 370. Recorder 370 receives and updates (using data interface 360) the corresponding portions of passenger data 310. Data interface 360 facilitates other blocks of RTR system 150 to store/retrieve passenger data 310, and may be implemented consistent with the implementation of data store 180, as will be apparent to one skilled in the relevant arts.

Network interface 320 also receives requests for recommendations from end user systems 110A-110Z or server systems 160A-160C and forwards them to stage processor 330. Stage processor 330, upon receiving a request for recommendations, first determines the current stage of the passenger on the current journey. In one embodiment, the requesting system includes an indication of the current stage in the request. Accordingly, stage processor 330 inspects the received request to determine the current stage. In an alternative embodiment, stage processor 330 periodically checks passenger data 310 to determine the current stage based on the activities of the passenger as noted above. In the scenario that the receives request contains information on the activities performed by the passenger or values of the profile parameters, stage processor 330 forwards the received details to recorder 370, which in turn updates (adds, modifies, deletes, etc.) passenger data 310 with the received details. Stage processor 330 forwards the determined current stage to recommender 350.

Recommender 350 identifies suitable recommendations for the current stage based on activities of the passenger in prior stages of the current journey. As such, recommender 350 first accesses passenger data 310 to determine the activities of the passenger in the prior stages, and then inspect a recommendation database (not shown) to identify the specific recommendations that would be suitable to the passenger for the current stage. Recommender 350 sends these recommendations to network interface 320, which in turn forwards (via path 145) the recommendations to the requesting system (one of end user systems 110A-110Z or server systems 160A-160C).

Thus, RTR system 150 facilitates a transportation provider to make recommendations for passengers at different stages related to journeys. It should be noted that in response to receiving the recommendations from RTR system 150 (directly or through a server system), an end user system (such as 110A-110Z) may display the recommendation to the passenger, thereby enabling the passenger to accept/reject the recommendations, perform activities associated with the recommendations, etc. Some sample recommendations that may be provided to a passenger at different stages related to a current journey is described below with examples.

### 5. Sample Recommendations

FIGS. 4A-4F depicts sample recommendations provided to a passenger at different stages related to a current journey. Broadly, each of the Figures depicts a corresponding portion of passenger data and the corresponding recommendations provided by RTR system 150 during the corresponding stage of the current journey.

For illustration, the passenger data and recommendations are shown according to extensible markup language (XML). However, in alternative embodiments, the passenger data and recommendations may be maintained/generated according to other data formats and/or using other data structures (such as a table in a relational database), as will be apparent to one skilled in the relevant arts by reading the disclosure herein. Each of the Figures is described in detail below.

FIG. 4A depicts portions of passenger data maintained and sample recommendations provided during booking stage of a current journey. It may be observed that the passenger data includes historical data such as the recent trips done by the passenger (the “RecentTrips” XML tag) and also profile data specifying the values for the various profile parameters such as Age, MaritalStatus, Kids, etc. (as indicated the correspondingly named XML tags). Furthermore, the passenger data includes a preferred location of the passenger (“Beach”), which may be obtained from a social web page of the passenger.

The passenger data also indicates the current location and current time of the passenger. The location and time may be obtained from an end user system (such as 110A-110Z) of the passenger. In one embodiment, a mobile application executing the mobile of the user may cause update of the passenger data with the current location/time of the passenger by sending (via path 145) appropriate packets to RTR system 150.

It may be observed that the recommendations (indicated by “Rec” XML tag) at the booking stage of the current journey specify locations which may be interest to the passenger. The recommended locations are provided both based on the preferred location of the passenger (“Beach” indicated by location type) and also based on the historical data (“Frequent” indicated by location type).

FIG. 4B depicts portions of passenger data maintained and sample recommendations provided during pre-flight stage of a current journey. For convenience, only the modified portion of the passenger data is shown in the Figure. It should be noted that the passenger data in each Figure includes all the portions depicted in the previous Figures as well.

Passenger data during the pre-flight stage indicates that the passenger has made a current booking (purchased tickets) during the booking phase. The details of the purchased tickets is shown updated in response to RTR system 150 receiving the details from a server application using which the passenger purchased the tickets. The current booking information indicates that the passenger's journey is from Bangalore to Miami on 25 Mar. 2016, with a return journey from Miami to Bangalore also captured.

The recommendations provided during the pre-flight stage include details of the weather at the destination (Miami), a list of clothing and other essentials that the passenger ought to pack for the journey, and a list of events happening at the destination (Miami) on or near the date of arrival of the flight at the destination. It may be appreciated that the recommendations related to the destination (Miami) are being provided based on the booking activity performed by the passenger in the booking stage (which is prior to the pre-flight stage).

FIG. 4C depicts portions of passenger data maintained and sample recommendations provided during check-in stage of a current journey. Passenger data during check-in stage indicates that the current location and time has been updated (based on packets received from a mobile application, as noted above). The recommendations during check-in stage includes reminder for checking in on the day before the date of the flight, reminder to select the seat and meal during check-in, a list of friends (identified based on the social media page of the passenger) who are present in the airport on the date of the flight, and suggested start time (and the corresponding reason) for going to the airport.

FIG. 4D depicts portions of passenger data maintained and sample recommendations provided during at-the-airport stage of a current journey. Passenger data during the at-the-airport stage captures details of the check-in activity performed by the passenger in the check-in stage of the journey. In particular, the passenger data indicates the meal preference and seat selected by the passenger. The recommendations provided during the at-the-airport stage include a list of restaurants and lounges of interest to the passenger. It may be appreciated that the recommendations of the restaurants (and possibly the lounges) is provided based on the meal preference selection activity performed by the passenger in the check-in stage (which is prior to the at-the-airport stage).

FIG. 4E depicts portions of passenger data maintained and sample recommendations provided during inside-the-aircraft stage of a current journey. Passenger data during the inside-the-aircraft stage captures details of the airport services used by the passenger in the at-the-airport stage of the journey. In particular, the passenger data indicates that the passenger had accessed (watched/browsed) a movie and a music album at one of the lounges recommended during the at-the-airport stage. The recommendations provided during the inside-the-aircraft stage include a list of In-Flight Entertainment (IFE) options of interest to the passenger. It may be appreciated that the recommendations of the IFE options is provided based on the airport services used by the passenger in the at-the-airport stage (which is prior to the inside-the-aircraft stage).

FIG. 4F depicts portions of passenger data maintained and sample recommendations provided during at-the-destination stage of a current journey. Passenger data during the at-the-destination stage indicates that the current location and time has been updated (based on packets received from a mobile application, as noted above). The recommendations provided during the at-the-destination stage include a list of car rentals available at the destination, and the point/carousel at which the baggage of the passenger can be collected.

Thus, RTR system 150 determines that the passenger is at different stages of the journey and provides recommendations accordingly, thereby improving the user experience during the journey.

It should be appreciated that the features described above can be implemented in various embodiments as a desired combination of one or more of hardware, executable modules, and firmware. The description is continued with respect to an embodiment in which various features are operative when executable modules are executed.

### 6. Digital Processing System

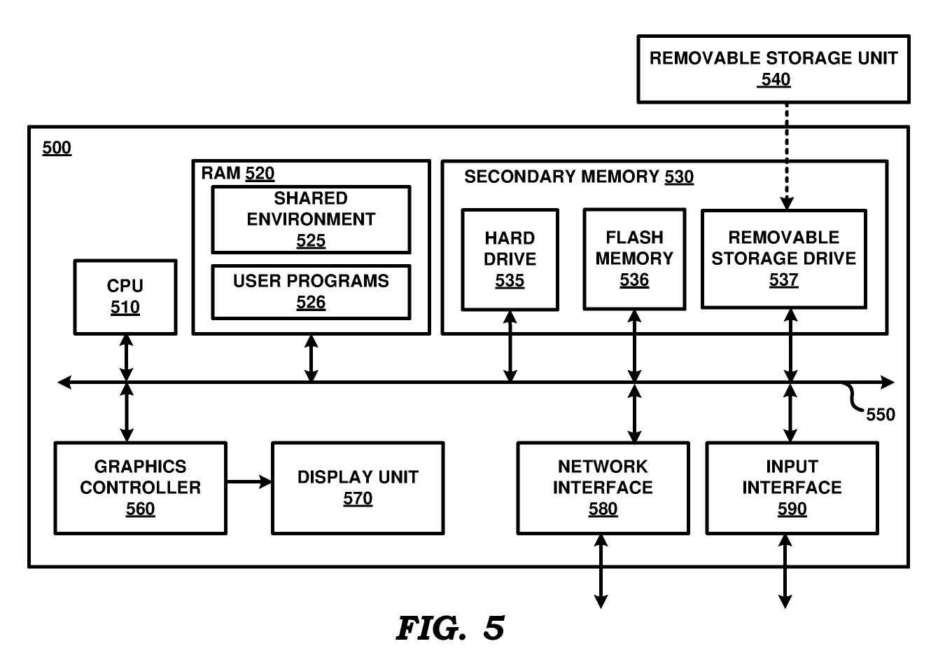

FIG. 5 is a block diagram illustrating the details of digital processing system 500 in which various aspects of the present disclosure are operative by execution of appropriate executable modules. Digital processing system 500 corresponds to RTR system 150.

Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present disclosure. CPU 510 may contain multiple processing units, with each processing unit potentially being designed for a specific task. Alternatively, CPU 510 may contain only a single general-purpose processing unit.

RAM 520 may receive instructions from secondary memory 530 using communication path 550. RAM 520 is shown currently containing software instructions constituting shared environment 525 and user programs 526. Shared environment 525 includes operating systems, device drivers, virtual machines, etc., which provide a (common) run time environment for execution of user programs 526.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse) and may be used to provide appropriate inputs. Network interface 580 provides connectivity to a network (e.g., using Internet Protocol), and may be used to communicate with other systems (of FIG. 1) connected to the network (120 and 140).

Secondary memory 530 may contain hard drive 535, flash memory 536, and removable storage drive 537. Secondary memory 530 may store the data (for example, portions of the data shown in FIGS. 4A-4F) and software instructions (for implementing the flowchart of FIG. 2), which enable digital processing system 500 to provide several features in accordance with the present disclosure. The code/instructions stored in secondary memory 530 may either be copied to RAM 520 prior to execution by CPU 510 for higher execution speeds, or may be directly executed by CPU 510.

Some or all of the data and instructions may be provided on removable storage unit 540, and the data and instructions may be read and provided by removable storage drive 537 to CPU 510. Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 530. Volatile media includes dynamic memory, such as RAM 520. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 550. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

What is claimed is:

1. A method of facilitating transportation providers to make recommendations for passengers at different stages related to journeys, said method comprising:
determining a current stage of a passenger on a current journey, said current journey containing a sequence of stages including said current stage;
identifying a set of recommendations for said current stage based on activities of said passenger in a first set of stages preceding said current stage according to said sequence; and
providing said set of recommendations to said passenger.

2. The method of claim 1, further comprising:
maintaining a passenger data indicating a corresponding set of activities performed by said passenger in each of said first set of stages, wherein said identifying identifies said set of recommendations by examining said passenger data; and
adding to said passenger data, a current set of activities performed by said passenger in said current stage.

3. The method of claim 2, wherein said passenger data also contains historical data and profile data,
said historical data indicating activities performed by said passenger during prior journeys preceding said current journey,
said profile data indicating values for various profile parameters of said passenger,
wherein said set of recommendations are identified by examining said historical data and said profile data, in addition to said corresponding set of activities.

4. The method of claim 3, wherein said current stage is a booking stage, wherein said historical data indicates a list of recent journeys of said passenger, wherein said profile data indicates a value for a preferred location parameter,
wherein said set of recommendations for said booking stage includes a list of possible destinations for said current journey, said list of possible destinations including a first destination that appears frequently in said list of recent journeys, said list of possible destinations also including a second destination based on said value for said preferred location parameter.

5. The method of claim 3, wherein said current stage is a pre-flight stage and said first set of stages includes a booking stage preceding said pre-flight stage,
wherein said passenger data includes details of a ticket purchased by said passenger in said booking stage, said ticket indicating a destination of said current journey of said passenger,
wherein said set of recommendations for said pre-flight stage includes information on the weather at said destination, a list of clothing and essentials that said passenger ought to pack for said current journey based on a location type of said destination, and a list of events happening at said destination.

6. The method of claim 3, wherein said current stage is an at-the-airport stage and said first set of stages includes a check-in stage preceding said at-the-airport stage,
wherein said passenger data includes a meal preference specified by a said passenger for said current journey in said check-in stage,
wherein said set of recommendations for said at-the-airport stage includes a list of restaurants in said airport matching said meal preference.

7. The method of claim 3, wherein said current stage is an inside-the-aircraft stage and said first set of stages includes an at-the-airport preceding said inside-the-aircraft,
wherein said passenger data indicates a list of airport services accessed by said passenger in said at-the-airport stage, said list of airport services including a first media accessed by said passenger at said airport,
wherein said set of recommendations for said inside-the-aircraft stage includes a list of In-Flight Entertainment (IFE) options matching said list of airport services, said list of IFE options containing said first media.

8. A non-transitory machine readable medium storing one or more sequences of instructions for causing a system to facilitate transportation providers to make recommendations for passengers at different stages related to journeys, wherein execution of said one or more instructions by one or more processors contained in said system causes said system to perform the actions of:
determining a current stage of a passenger on a current journey, said current journey containing a sequence of stages including said current stage;
identifying a set of recommendations for said current stage based on activities of said passenger in a first set of stages preceding said current stage according to said sequence; and
providing said set of recommendations to said passenger.

9. The non-transitory machine readable medium of claim 8, further comprising one or more instructions for:
maintaining a passenger data indicating a corresponding set of activities performed by said passenger in each of said first set of stages, wherein said identifying identifies said set of recommendations by examining said passenger data; and
adding to said passenger data, a current set of activities performed by said passenger in said current stage.

10. The non-transitory machine readable medium of claim 9, wherein said passenger data also contains historical data and profile data,
said historical data indicating activities performed by said passenger during prior journeys preceding said current journey,
said profile data indicating values for various profile parameters of said passenger,
wherein said set of recommendations are identified by examining said historical data and said profile data, in addition to said corresponding set of activities.

11. The non-transitory machine readable medium of claim 10, wherein said current stage is a booking stage, wherein said historical data indicates a list of recent journeys of said passenger, wherein said profile data indicates a value for a preferred location parameter,
wherein said set of recommendations for said booking stage includes a list of possible destinations for said current journey, said list of possible destinations including a first destination that appears frequently in said list of recent journeys, said list of possible destinations also including a second destination based on said value for said preferred location parameter.

12. The non-transitory machine readable medium of claim 10, wherein said current stage is a pre-flight stage and said first set of stages includes a booking stage preceding said pre-flight stage,
wherein said passenger data includes details of a ticket purchased by said passenger in said booking stage, said ticket indicating a destination of said current journey of said passenger,
wherein said set of recommendations for said pre-flight stage includes information on the weather at said destination, a list of clothing and essentials that said passenger ought to pack for said current journey based on a location type of said destination, and a list of events happening at said destination.

13. The non-transitory machine readable medium of claim 10, wherein said current stage is an at-the-airport stage and said first set of stages includes a check-in stage preceding said at-the-airport stage,
wherein said passenger data includes a meal preference specified by a said passenger for said current journey in said check-in stage,
wherein said set of recommendations for said at-the-airport stage includes a list of restaurants in said airport matching said meal preference.

14. The non-transitory machine readable medium of claim 10, wherein said current stage is an inside-the-aircraft stage and said first set of stages includes an at-the-airport preceding said inside-the-aircraft,
wherein said passenger data indicates a list of airport services accessed by said passenger in said at-the-airport stage, said list of airport services including a first media accessed by said passenger at said airport,
wherein said set of recommendations for said inside-the-aircraft stage includes a list of In-Flight Entertainment (IFE) options matching said list of airport services, said list of IFE options containing said first media .

15. A digital processing system comprising:
a processor;
a random access memory (RAM);
a machine readable medium to store one or more instructions, which when retrieved into said RAM and executed by said processor causes said digital processing system to facilitate transportation providers to make recommendations for passengers at different stages related to journeys, said digital processing system performing the actions of:
determining a current stage of a passenger on a current journey, said current journey containing a sequence of stages including said current stage;
identifying a set of recommendations for said current stage based on activities of said passenger in a first set of stages preceding said current stage according to said sequence; and
providing said set of recommendations to said passenger.

16. The digital processing system of claim 15, further performing the actions of:
maintaining a passenger data indicating a corresponding set of activities performed by said passenger in each of said first set of stages, wherein said identifying identifies said set of recommendations by examining said passenger data; and
adding to said passenger data, a current set of activities performed by said passenger in said current stage.

17. The digital processing system of claim 16, wherein said passenger data also contains historical data and profile data,
said historical data indicating activities performed by said passenger during prior journeys preceding said current journey,
said profile data indicating values for various profile parameters of said passenger,
wherein said set of recommendations are identified by examining said historical data and said profile data, in addition to said corresponding set of activities.

18. The digital processing system of claim 17, wherein said current stage is a pre-flight stage and said first set of stages includes a booking stage preceding said pre-flight stage,
wherein said passenger data includes details of a ticket purchased by said passenger in said booking stage, said ticket indicating a destination of said current journey of said passenger,
wherein said set of recommendations for said pre-flight stage includes information on the weather at said destination, a list of clothing and essentials that said passenger ought to pack for said current journey based on a location type of said destination, and a list of events happening at said destination.

19. The digital processing system of claim 17, wherein said current stage is an at-the-airport stage and said first set of stages includes a check-in stage preceding said at-the-airport stage,
wherein said passenger data includes a meal preference specified by a said passenger for said current journey in said check-in stage,
wherein said set of recommendations for said at-the-airport stage includes a list of restaurants in said airport matching said meal preference.

20. The digital processing system of claim 17, wherein said current stage is an inside-the-aircraft stage and said first set of stages includes an at-the-airport preceding said inside-the-aircraft,
wherein said passenger data indicates a list of airport services accessed by said passenger in said at-the-airport stage, said list of airport services including a first media accessed by said passenger at said airport,
wherein said set of recommendations for said inside-the-aircraft stage includes a list of In-Flight Entertainment (IFE) options matching said list of airport services, said list of IFE options containing said first media.
